(19) United States
(12) Patent Application Publication
(10) Pub. No.: US 2005/0076430 A1
(43) Pub. Date: Apr. 14, 2005

(54) Sauna cabin assembly system and method

(76) Inventor: Chang Hwan Lee, Cerritos, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/683,883

(22) Filed: Oct. 9, 2003

(51) Int. Cl. A61H 33/06

(52) U.S. Cl. 4/524

(57) ABSTRACT

A sauna cabin assembly system, for enabling the assembly of a front panel of a sauna cabin to each of a pair of side panels of the sauna cabin. The system is able to hide multiple securing elements for securing the front panel and each of the pair of side panels together. The system includes multiple front panel edge securing elements, and multiple side panel edge securing elements which are complementary to and interengageable with the multiple front panel edge securing elements. It enables the assembly of the sauna cabin front panel to each of the pair of sauna cabin side panels, so as to hide the multiple securing elements.

### BACKGROUND OF THE INVENTION

1. Field of the Invention

The present invention relates generally to a sauna cabin assembly, and, more particularly, relates to a an assembly system for enabling the securing of a sauna frontal panel and a pair of sauna side panels together.

2. Description of the Related Art

A sauna cabin is able to be assembled from pre-fabricated panels, including a front panel and a pair of side panels. It is desirable to enable the front panel and the pair of side panels to be secured together such that the securing elements are not visible on the outside surfaces thereof.

Therefore, there has existed a need for a system which is capable of securing the front panel and the pair of side panels together so that the securing elements are not visible. The present invention fulfills these needs.

### SUMMARY OF THE INVENTION

Briefly, and in general terms, the present invention enables the assembly of a front panel of a sauna cabin to each of a pair of side panels of the sauna cabin, so as to hide a plurality of securing elements for securing the front panel and each of the pair of side panels together.

The system includes multiple securing elements, including multiple front panel edge securing elements, and multiple side panel edge securing elements which are complementary to and interengageable with the multiple front panel edge securing elements, to enable the assembly of the sauna cabin front panel to each of the pair of sauna cabin side panels, so as to hide the multiple securing elements.

Other features and advantages will become apparent from the following detailed description, taken in conjunction with the accompanying drawings, which describe and illustrate, by way of example, the features of the invention.

### BRIEF DESCRIPTION OF THE DRAWINGS

FIG. 1 is an elevational view of a front panel and side panel securing elements of a sauna cabin assembly system in accordance with the present invention.

FIG. 2 is a side elevational view of a front panel and front panel securing elements of a sauna cabin assembly system in accordance with the present invention.

FIG. 3 is a top plan view of a front panel and side panels of a sauna cabin assembly system in accordance with the present invention.

FIG. 4 is a an elevational view of a securing element in accordance with the present invention.

FIG. 5 is a an exploded perspective view of a sauna cabin in accordance with the present invention.

FIG. 6 is a perspective view of an assembled sauna cabin in accordance with the present invention.

### DETAILED DESCRIPTION OF THE PREFERRED EMBODIMENTS

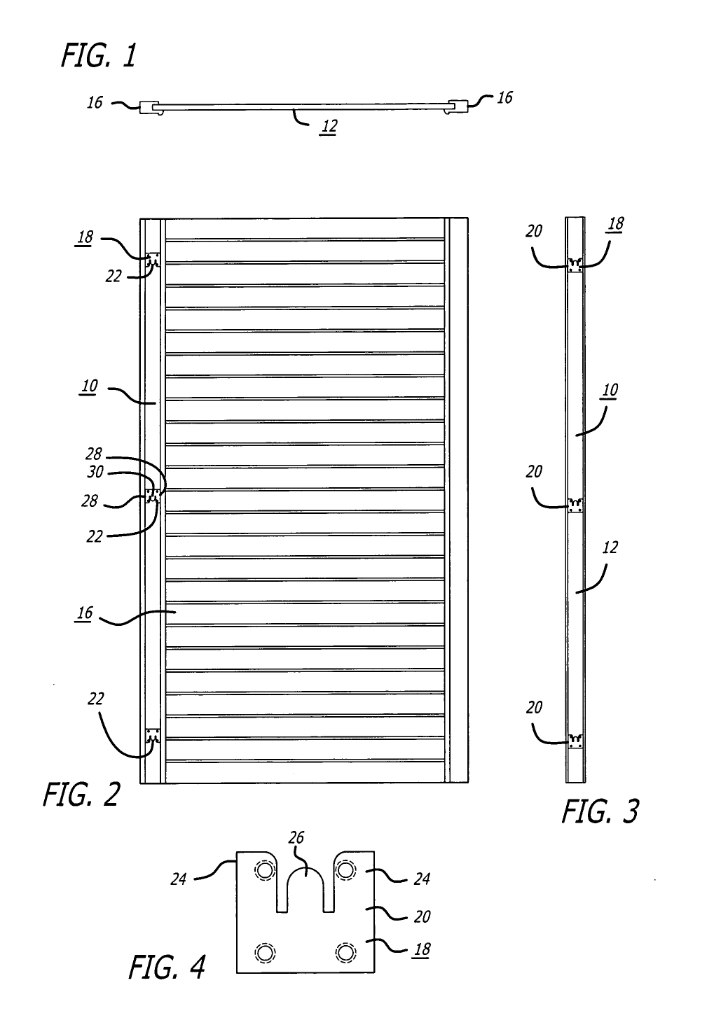

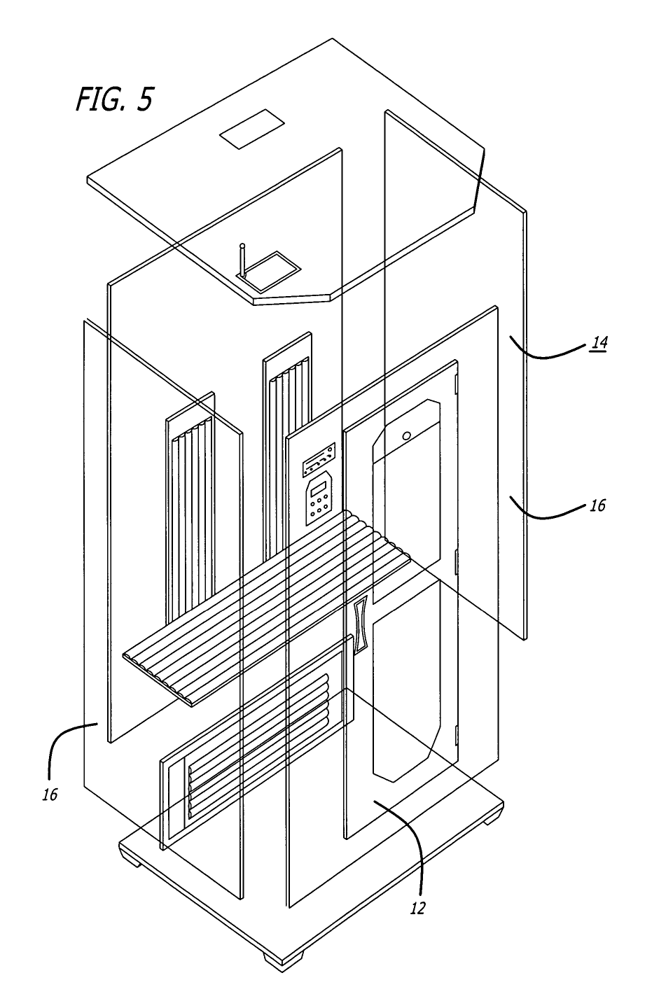

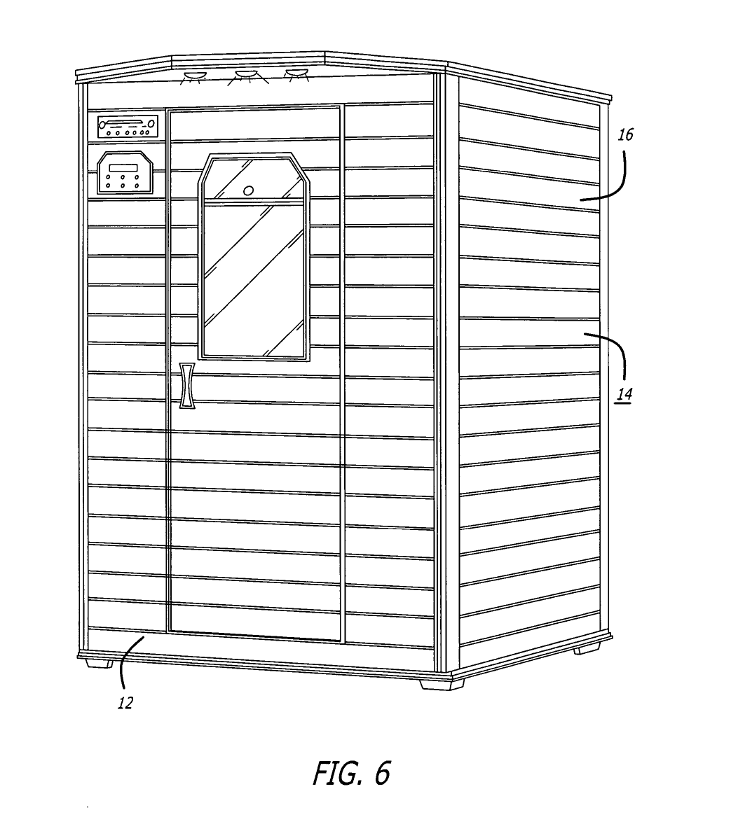

Referring to the drawings, and in particular to FIGS. 1-6, there is shown a sauna cabin assembly system 10, for enabling the assembly of a front panel 12 of a sauna cabin 14 to each of a pair of side panels 16 of the sauna cabin 14, so as to hide a plurality of securing elements 18 for securing the front panel 12 and each of the pair of side panels 16 together.

The system includes a plurality of securing elements 18, including a plurality of front panel edge securing elements 20, and a plurality of side panel edge securing elements 22 which are complementary to and interengageable with the plurality of front panel edge securing elements 20. The plurality of securing elements 18 enable the assembly of the sauna cabin front panel 12 to each of the pair of sauna cabin side panels 16, so as to hide the plurality of securing elements 18.

Each of the plurality of front panel edge securing elements 20 comprises a front panel edge bracket. Each of the plurality of front panel edge brackets 20 includes a pair of side securable portions 24 and a medial interengageable portion 26. Each of the plurality of front panel edge brackets 20 is generally w-shaped.

Each of the plurality of side panel edge securing elements 22 comprises a side panel edge bracket. Each of the plurality of side panel edge brackets 22 includes a pair of side securable portions 28 and a medial interengageable portion 30. The pair of side securable portions 28 of each of the plurality of side panel edge brackets 22 are securable to one of the pair of side panels 16, and the medial interengageable portion 30 of each of the plurality of side panel edge brackets 22 is engageable with the medial interengageable portion 26 of each of the plurality of front panel edge brackets 20. Each of the plurality of side panel edge brackets 22 is generally m-shaped.

As illustrated in FIGS. 1-6, in a method for use of the system 10, the sauna cabin front panel 12 is assembled to each of the pair of sauna cabin side panels 16 by interengaging the plurality of front panel edge securing elements 20 with the complimentary and interengageble plurality of side panel edge securing elements 22.

1. A sauna cabin assembly system, for enabling the assembly of a front panel of a sauna cabin to each of a pair of side panels of the sauna cabin, so as to hide a plurality of securing elements for securing the front panel and each of the pair of side panels together, comprising:
a plurality of securing elements, including a plurality of front panel edge securing elements, and a plurality of side panel edge securing elements which are complementary to and interengageable with the plurality of front panel edge securing elements, to enable the assembly of the sauna cabin front panel to each of the pair of sauna cabin side panels, so as to hide the plurality of securing elements.

2. The system of claim 1, wherein each of the plurality of front panel edge securing elements comprises a front panel edge bracket.

3. The system of claim 1, wherein each of the plurality of side panel edge securing elements comprises a side panel edge bracket.

4. The system of claim 2, wherein each of the plurality of front panel edge brackets includes a pair of side securable portions and a medial interengageable portion.

5. The system of claim 3, wherein each of the plurality of side panel edge brackets includes a pair of side securable portions and a medial interengageable portion.

6. The system of claim 4, wherein each of the plurality of side panel edge brackets includes a pair of side securable portions and a medial interengageable portion, and wherein the pair of side securable portions of each of the plurality of side panel edge brackets are securable to one of the pair of side panels and the medial interengageable portion of each of the plurality of side panel edge brackets is engageable with the medial interengageable portion of each of the plurality of front panel edge brackets.

7. The system of claim 4, wherein each of the plurality of front panel edge brackets comprises a generally w-shaped bracket.

8. The system of claim 5, wherein each of the plurality of side panel edge brackets comprises a generally m-shaped bracket.

9. A sauna cabin assembly system, for enabling the assembly of a front panel of a sauna cabin to each of a pair of side panels of the sauna cabin, so as to hide a plurality of securing elements for securing the front panel and each of the pair of side panels together, comprising:
securing means, including front panel edge securing means, and side panel edge securing means which are complementary to and interengageable with the front panel edge securing means, to enable the assembly of the sauna cabin front panel to each of the pair of sauna cabin side panels, so as to hide the securing means.

10. A method of assembling a sauna cabin, for enabling the assembly of a front panel of the sauna cabin to each of a pair of side panels of the sauna cabin, so as to hide a plurality of securing elements for securing the front panel and each of the pair of side panels together, in a system which includes a plurality of securing elements, including a plurality of front panel edge securing elements, and a plurality of side panel edge securing elements which are complementary to and interengageable with the plurality of front panel edge securing elements, to enable the assembly of the sauna cabin front panel to each of the pair of sauna cabin side panels, so as to hide the plurality of securing elements, wherein the method comprises:
assembling the sauna cabin front panel to each of the pair of sauna cabin side panels, comprising interengaging the plurality of front panel edge securing elements with the complimentary and interengageble plurality of side panel edge securing elements.

11. The method of claim 10, wherein each of the plurality of front panel edge securing elements comprises a front panel edge bracket, and wherein interengaging comprises interengaging each of the plurality of front panel edge brackets with the complimentary and interengageable plurality of side panel edge securing elements.

12. The method of claim 10, wherein each of the plurality of side panel edge securing elements comprises a side panel edge bracket, and wherein interengaging comprises interengaging each of the plurality of side panel edge brackets with the complementary and interengageable plurality of front panel edge securing elements.

13. The method of claim 11, wherein each of the plurality of front panel edge brackets includes a pair of side securable portions and a medial interengageable portion, and wherein interengaging comprises interengaging the medial interengageable portion of each of the plurality of front panel edge brackets with the complementary and interengageable plurality of side panel edge securing elements.

14. The method of claim 12, wherein each of the plurality of side panel edge brackets includes a pair of side securable portions and a medial interengageable portion, and wherein interengaging comprises interengaging the medial interengageable portion of each of the side panel edge brackets with the complementary and interengageable plurality of front panel edge securing elements.

15. The method of claim 13, wherein each of the plurality of side panel edge brackets includes a pair of side securable portions and a medial interengageable portion, and wherein each front panel medial interengageable portion is engageable with a side panel medial interengageable portion, and wherein interengaging comprises interengaging the medial interengageable portion of each of the plurality of side panel edge brackets with the medial interengageable portion of each of the complementary and interengagable plurality of front panel edge brackets.

16. The method of claim 13, wherein each of the plurality of front panel edge brackets comprises a generally w-shaped bracket, and wherein interengaging comprises interengaging the plurality of generally w-shaped front panel edge brackets with the complementary and interengagable plurality of side panel edge brackets.

17. The method of claim 14, wherein each of the plurality of side panel edge brackets comprises a generally m-shaped bracket, and wherein interengaging comprises interengaging the generally m-shaped side panel edge securing elements with the complementary and interengagable plurality of front panel edge securing elements.

18. A method of assembling a sauna cabin, for enabling the assembly of a front panel of a sauna cabin to each of a pair of side panels of the sauna cabin, so as to hide a plurality of securing elements for securing the front panel and each of the pair of side panels together, in a system which includes securing means, including front panel edge securing means, and side panel edge securing means which are complementary to and interengageable with the front panel edge securing means, to enable the assembly of the sauna cabin front panel to each of the pair of sauna cabin side panels, so as to hide the securing means, wherein the method comprises:
assembling the sauna cabin front panel to each of the pair of sauna cabin side panels, comprising interengaging the plurality of front panel edge securing means with the complementary and interengageable plurality of side panel edge securing means.
